(19) United States
(12) Patent Application Publication
(10) Pub. No.: US 2022/0237726 A1
(43) Pub. Date: Jul. 28, 2022

(54) Comprehensive Evaluation Method of Military Training Level Based on Multi-source Data Fusion Model

(71) Applicants: AEROSPACE INTERNET OF THINGS TECHNOLOGY CO., LTD., Beijing (CN); CHINA AEROSPACE TIMES ELECTRONICS CO., LTD., Beijing (CN)

(72) Inventors: SHUYU ZHANG, BEIJING (CN); SHUMENG WANG, BEIJING (CN); XIAO YANG, BEIJING (CN); FENGTING SHEN, BEIJING (CN); XUELIN YANG, BEIJING (CN)

(21) Appl. No.: 17/717,846

(22) Filed: Apr. 11, 2022

Related U.S. Application Data
(63) Continuation of application No. PCT/CN2020/115728, filed on Sep. 17, 2020.

(30) Foreign Application Priority Data
Jul. 2, 2020 (CN) 2020106329198

(51) Int. Cl. G06Q 50/26; G06Q 10/06

(52) U.S. Cl. CPC G06Q 50/26; G06Q 10/06393

(57) ABSTRACT

A comprehensive evaluation method of military training level includes: selecting evaluation indicators of military training level, and establishing an evaluation indicator system of military training level by a multi-tree structure; constructing a leaf node evaluation indicator fusion model including a time indicator fusion model and a quality indicator fusion model, and performing multi-source data fusion processing on leaf node indicator data through the leaf node evaluation indicator fusion model; constructing a leaf node evaluation indicator model of military training level; constructing a parent node evaluation indicator model of military training level based on weight information of evaluation indicators of military training level of nodes in the multi-tree structure; and constructing a total indicator evaluation model by a method of breadth first search of multi-tree to complete the comprehensive evaluation of military training level. The method of the invention can perform comprehensive evaluation of military training level scientifically, reasonably and efficiently.

### TECHNICAL FIELD

The application relates to comprehensive evaluation technology and application field, in particular to a comprehensive evaluation method of military training level based on a multi-source data fusion model.

### BACKGROUND

Military training evaluation is a systematic analysis and appraisement of the overall effect and comprehensive level of personnel and equipment training by the army commanders and command organs according to the standards of combat effectiveness and support capability. Military training evaluation is essentially a feedback of training information and an appraisement of training effects. Military training is an important way to improve combat effectiveness of troops, while military training evaluation is an important part of the training management of troops, an important means to test training effects and promote the implementation of trainings, and also a key way to stimulate the training enthusiasm of troops and promote the innovation and development of trainings, so as to improve combat effectiveness. Foreign troops attach great importance to military training evaluation, which is regarded as an independent stage in the military training cycle. After years of research, exploration and practice, Chinese army's military training evaluation has made some progress. The existing evaluation methods of military training level respectively evaluate the indicators with different source data or directly transform the data record types of indicators, first force the unified data types of indicators and then add them comprehensively, so as to realize the purpose of system indicator evaluation. However, this method has cumbersome manual operations as well as subjective results, and there are many problems such as large qualitative evaluations, little quantitative evaluations, absence of scientific evaluation methods and unified evaluation standards. At present, the army is developing towards actual combat, digitalization and informatization, and the composition of combat effectiveness is diversified, which puts forward higher requirements for the evaluation of military training level.

Therefore, how to provide a scientific, reasonable and efficient method to evaluate the military training level is an urgent technical problem.

### SUMMARY

The objective of the application is to provide a comprehensive evaluation method of military training level based on a multi-source data fusion model to solve the technical problems existing in the prior art, so as to perform comprehensive evaluation of military training level scientifically, reasonably and efficiently.

To achieve the above objectives, the application provides the following scheme: a comprehensive evaluation method of military training level based on a multi-source data fusion model including the following steps:

selecting evaluation indicators of military training level, and establishing an evaluation indicator system of military training level by using a multi-tree structure;

constructing a leaf node evaluation indicator fusion model of military training level based on a multi-source data fusion algorithm; the leaf node evaluation indicator fusion model includes a time indicator fusion model and a quality indicator fusion model; the time indicator fusion model is constructed based on an improved sigmoid function while the quality indicator fusion model is constructed based on a percentage of completion quality of military training actions; and performing multi-source data fusion processing on leaf node indicator data through the leaf node evaluation indicator fusion model of military training level;

constructing a leaf node evaluation indicator model of military training level, based on the multi-tree structure of the evaluation indicator system of military training level and leaf node evaluation indicator data after the multi-source data fusion processing (also referred to multi-source data fusion processed leaf node evaluation indicator data);

constructing a parent node evaluation indicator model of military training level is based on weight information of evaluation indicators of military training level in the multi-tree structure of the evaluation indicator system of military training level;

constructing a total indicator evaluation model of military training level by using a method of breadth first search of multi-tree, based on the leaf node evaluation indicator model of military training level and the parent node evaluation indicator model of military training level, to thereby complete a comprehensive evaluation of military training level.

Preferably, the time indicator fusion model is shown in Formula 2:

$$v = \frac{1}{1 + {e}^{α t - β}} , v ∈ ( 0 , 1 ) \qquad Formula 2$$

in which the expression of βis shown in Formula 3:

$$β = α {t}_{{stan}^{.}} - ln ( \frac{1}{{v}_{stan}} - 1 ) , β ∈ ( 0 , 1 ) \qquad Formula 3$$

in which t represents the actual time of military training actions, v represents the actual completion speed of military training actions, α and β represent the slope factor and bias factor respectively, tₛₜₐₙ represents the standard time of military training actions, vₛₜₐₙ represents the standard completion speed of military training actions corresponding to tₛₜₐₙ, and vₛₜₐₙ=f(β−atₛₜₐₙ), herein ^{f} represents a function.

The quality indicator fusion model is shown in Formula 4:

$$q = \frac{m}{{m}_{total}} , q ∈ ( 0 , 1 ) \qquad Formula 4$$

in which m represents the number of correct actions in the military training operations, and mₜₒₜₐₗ represents the total number of actions in the military training operations. Preferably, the military training level leaf node evaluation indicator model (i.e., leaf node evaluation indicator model s of military training level) is shown in Formula 5:

$$s = \{ \begin{matrix}v \times 100 = \frac{1}{1 + {e}^{α t - β}} \times 100 , & \begin{matrix}when the leaf node is a time \\ indicator\end{matrix} \\ q \times 100 = \frac{m}{{m}_{total}} \times 100 , & \begin{matrix}when the leaf node is a quality \\ indicator\end{matrix}\end{matrix} \qquad Formula 5$$

Preferably, the military training level parent node evaluation indicator model (i.e., parent node evaluation indicator model S of military training level) is shown in

Formula 6:

$$S = {\sum }_{i = 1}^{N} \frac{{w}_{i}}{{\sum }_{j = 1}^{N} {w}_{i}} {s}_{i} \qquad Formula 6$$

in which N represents the number of child nodes owned by the parent node, sᵢ, represents the indicator evaluation result of the i-th child node, and wᵢ, represents the indicator weight of the i-th child node.

Preferably, the method of breadth first search of multi-tree is implemented by a queue.

Preferably, the method of breadth first search of multi-tree with the bottom-up and hierarchical weighted summation is used to construct the total indicator evaluation model of military training level.

The invention discloses the technical effects that according to the method, the military training level evaluation data is subjected to nonlinear normalization processing based on the improved Sigmoid function, so that multi-source data fusion and dimensionless processing of indicators are realized; according to the structural characteristics of the evaluation indicator system of military training level, the evaluation indicator system is represented by multi-tree structure; based on the normalized result of multi-source data fusion, the evaluation model of leaf node indicator is constructed; based on the weight parameters of child node indicators, the evaluation model of parent node indicators is constructed; based on the evaluation model of leaf node indicator and parent node indicator, the evaluation model of each level indicator and total indicator is constructed by the bottom-up and hierarchical weighted summation using the breadth first search algorithm of multi-tree. This method realizes a more scientific, reasonable and efficient evaluation of system indicators.

The method of the invention can be applied not only to the evaluation of military training level, but also to the application of comprehensive evaluation in other fields related to indicator system, and provides an effective solution for comprehensive evaluation of system indicators from the perspective of data fusion and analysis technology.

### BRIEF DESCRIPTION OF DRAWINGS

In order to more clearly explain the embodiments of the invention or the technical solutions in the prior art, the drawings needed in the embodiments will be briefly introduced below. Obviously, the drawings in the following description are only some embodiments of the invention, and for those of ordinary skill in the field, other drawings can be obtained according to these drawings without paying creative efforts.

FIG. 1 is a flow chart of the comprehensive evaluation method of military training based on multi-source data fusion model of the application;

FIG. 2 is a normalization curve based on the improved sigmoid function in an embodiment of the invention;

FIG. 3 is a schematic diagram of the multi-tree structure of the military training level evaluation indicator system in the embodiment of the invention;

FIG. 4 is a schematic diagram of a method for implementing breadth first search based on queues in an embodiment of the invention.

### DETAILED DESCRIPTION OF EMBODIMENTS

The technical solutions in the embodiments of the invention will be clearly and completely illustrated with reference to the drawings in the embodiments of the invention. Apparently, the described embodiments are only part of the embodiments of the invention rather than all of them. Based on the embodiments in the invention, all other embodiments obtained by those of ordinary skill in the field without creative work are within the scope of the invention.

In order to make the above objectives, features and advantages of the invention more obvious and easier to understand, the invention will be illustrated in further detail below with reference to the drawings and detailed description.

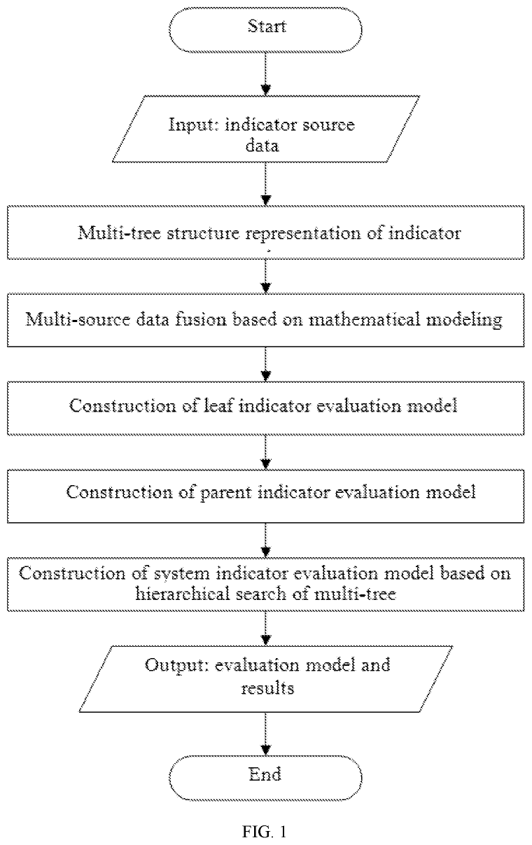

Referring to FIGS. 1-4, this embodiment provides a comprehensive evaluation method of military training based on multi-source data fusion model, which specifically includes the following steps:

S1, selecting the evaluation indicator of military training level, and establishing the evaluation indicator system of military training level by using multi-tree structure.

According to the structural characteristics of the evaluation indicator system of military training level, the evaluation indicator system of military training level is represented by multi-tree structure, wherein the total indicator is represented by the root node of the multi-tree which is the top parent node; the next level indicator of the total indicator is represented by the child nodes of the root node, and so on. According to the subordinate relationship of each level indicator, the evaluation indicator system of military training level is expressed as a multi-tree structure. Among them, the lowest indicator is the lowest child node, namely the leaf node. Construct a multi-tree of width-first search of indicator system, which lays a foundation for the subsequent construction of indicator evaluation models of different levels, and is also convenient for programming to automatically calculate the indicator values of each level.

In this embodiment, the multi-tree structure of the military training level evaluation indicator system (also referred to as the evaluation indicator system of military training level) is shown in FIG. 3. In the multi-tree structure of the military training level evaluation indicator system, the corresponding relationship between each node and the indicator is: the total indicator is the root node; primary sub-indicator A, B and C are the child nodes of the total indicator and the parent nodes of the secondary sub-indicator; secondary sub-indicators D, E, F, G, H, I, J, K and L are the child nodes of primary sub-indicators, namely the leaf nodes. The parent-child relationship between the nodes where the total indicator, the primary sub-indicator and the secondary sub-indicator are located is as follows: A, B and C are the child nodes of the root node R; D, E and F are the child nodes of the parent node A; G and H are the child nodes of the parent node B; I, J, K and L are the child nodes of the parent node C.

S2, constructing a military training level leaf node evaluation indicator fusion model based on multi-source data fusion algorithm, and performing multi-source data fusion processing on leaf node indicator data through the military training level leaf node evaluation indicator fusion model (also referred to as leaf node evaluation indicator fusion model of military training level).

Due to the diversity of data sources, the evaluation indicators of military training level are divided into time-based indicators and quality-based indicators. Both time-based indicators and quality-based indicators contain multiple dimensions, and the required data storage structures are different. Therefore, different methods are used to normalize the time-based indicators and quality-based indicators to realize multi-source data fusion.

Aiming at the time-based indicators, the improved sigmoid function is used for nonlinear normalization of data, and a time indicator fusion model is constructed. Among them, sigmoid is a smooth step function, which can convert any numerical value into an interval value from 0 to 1. sigmoid function is shown in Formula (1):

$$y = f ( x ) = \frac{1}{1 + {e}^{- x}} , y ∈ ( 0 , 1 ) \qquad ( 1 )$$

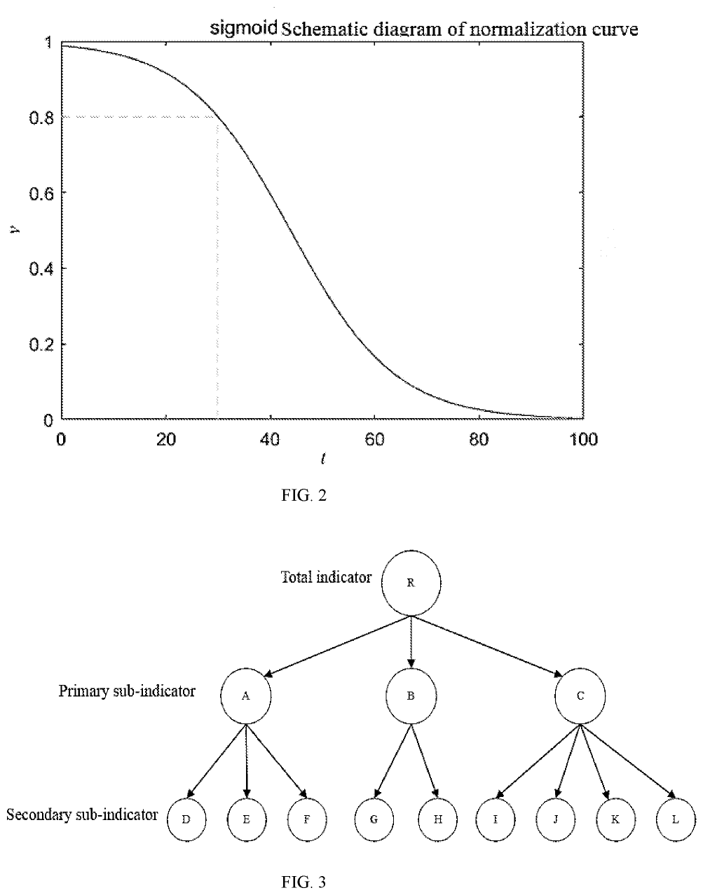

Let x=β−at, y=v, improve the sigmoid function, and the improved sigmoid function is shown in Formula (2):

$$v = \frac{1}{1 + {e}^{α t - β}} , v ∈ ( 0 , 1 ) \qquad ( 2 )$$

in which the expression of β is shown in Formula (3):

$$β = α {t}_{{stan}^{.}} - ln ( \frac{1}{{v}_{stan}} - 1 ) , β ∈ ( 0 , 1 ) \qquad ( 3 )$$

in which t represents the actual duration of military training action, v represents the actual completion speed of military training action, α and β represent the slope factor and bias factor respectively, tₛₜₐₙ indicates the time of military training action standard, which is determined according to relevant technical standards; vₛₜₐₙ represents the standard completion speed of military training action corresponding to the standard time of military training action tₛₜₐₙ, that is vₛₜₐₙ=f(β−atₛₜₐₙ). Formula (2) realizes dimensionless treatment of time indicator, that is, time indicator model. The normalized curve based on the improved sigmoid function is shown in FIG. 2.

Based on the quality measurement indicators, calculate the percentage of completed quality of military training operations, realize dimensionless treatment of quality indicators, and complete the construction of quality indicators fusion model, as shown in Formula (4):

$$q = \frac{m}{{m}_{total}} , q ∈ ( 0 , 1 ) \qquad ( 4 )$$

in which m represents the number of correct actions in military training operations, and mₜₒₜₐₗ represents the total number of actions in military training operations.

By constructing a time indicator fusion model and a quality indicator fusion model, the units and values of data from various sources can be standardized, and finally multi-source data fusion can be realized, and the indicator model of the underlying capacity can be obtained.

S3, based on the multi-tree structure of the military training level evaluation indicator system and the leaf node evaluation indicator data after multi-source data fusion, the evaluation indicator model of military training level leaf node is constructed.

The evaluation indicator model s of military training level in the leaf node is a percentage system, as shown in Formula (5):

$$s = \{ \begin{matrix}v \times 100 = \frac{1}{1 + {e}^{α t - β}} \times 100 , & \begin{matrix}when the leaf node is a time \\ indicator\end{matrix} \\ q \times 100 = \frac{m}{{m}_{total}} \times 100 , & \begin{matrix}when the leaf node is a quality \\ indicator\end{matrix}\end{matrix} \qquad ( 5 )$$

S4, based on the weight information of each node's military training level evaluation indicator in the multi-tree structure of the military training level evaluation indicator system, the parent node evaluation indicator model of military training level is constructed.

The evaluation indicator model S of military training level parent node is shown in Formula (6):

$$S = {\sum }_{i = 1}^{N} \frac{{w}_{i}}{{\sum }_{j = 1}^{N} {w}_{i}} {s}_{i} \qquad ( 6 )$$

in which N represents the number of child nodes owned by the parent node; Sᵢ represents the indicator evaluation result of the i-th child node; and Wᵢ, represents the indicator weight of the i-th child node, which can be directly assigned by the subjective weighting method, that is, the weight of each indicator can be determined by expert knowledge and experience.

S5, based on the leaf node evaluation indicator model of military training level and the parent node evaluation indicator model of military training level, the total indicator evaluation model of military training level is constructed by breadth first search of multi-tree.

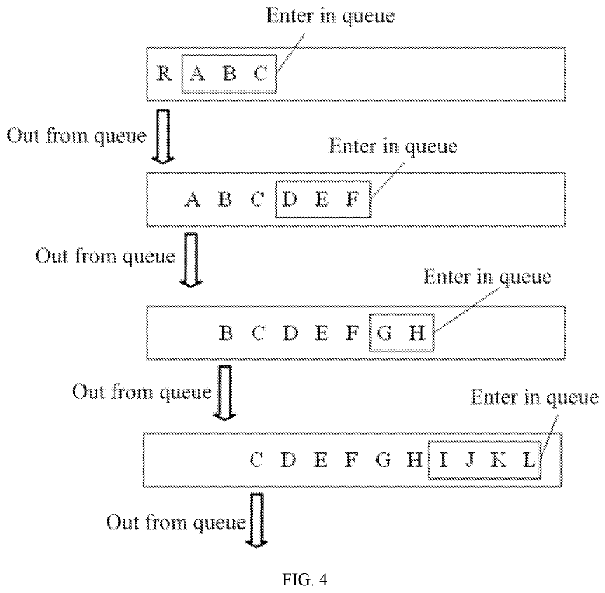

breadth first search, also known as width-first search, hierarchy-first search or lateral-first search, refers to traversing the nodes of the tree from the root node along the width of the tree until all nodes have been traversed. The method of breadth first search traverses the multi-tree layer by layer, and introduces the queue as a data structure to help realize the method of breadth first search. The schematic diagram of the method breadth first search based on the queue is shown in FIG. 4. First, the root node is queued, and then it is judged whether the child node is empty; if not, the corresponding child node is queued. For the multi-tree structure of military training level evaluation indicator system in FIG. 3, the specific sequence of breadth first search is R→A→B→C→D→E→F→G→H→I→J→K→L.

Take the multi-tree structure of the military training level evaluation indicator system in FIG. 3 as an example. Based on the multi-tree breadth first (hierarchical) search method (i.e., method of breadth first search of multi-tree), the invention adopts the bottom-up and the hierarchical weighted summation method to build the comprehensive evaluation model of the indicator system; then, the evaluation model of leaf node indicators D, E, F, G, H, I, J, K and L is constructed according to Formula (5); according to the parent-child relationship among nodes at each level, the evaluation model of primary sub-indicators A, B, C and total indicator R is constructed according to Formula (6); finally, the total indicator evaluation model of military training level is constructed.

Compared with the prior art, the method of the invention can fuse multi-source data and construct a comprehensive evaluation model of the military training level evaluation indicator system, which is a scientific and efficient evaluation method. The invention of the comprehensive evaluation method of military training level based on multi-source data fusion model provides a practical implementation scheme for scientific and comprehensive evaluation of military training level, solves the problem that system indicators composed of various types of source data are difficult to be uniformly evaluated, and thus makes objective evaluations as well as truly reflects the operation skills and command level of the trained troops. The method also provides a reference for better developing the training evaluation system and promoting the training quality of troops. In addition, the method of the invention has a wide range of potential applications, and can be used for problems related to comprehensive evaluation of system indicators in the fields of military affairs, finance, sports, education and the like, and provides an effective solution for comprehensive evaluation of system indicators from the perspective of data fusion and analysis technology.

In the description of the invention, it should be understood that the terms of vertical, horizontal, up, down, front, back, left, right, top, bottom, inside and outside, which indicated orientations or positional relationships are based on the orientations or positional relationships shown in the drawings, only for the convenience of describing the application, rather than indicate or imply that the indicated devices or elements must have a specific orientation, be constructed and operated in a specific orientation, and therefore cannot be understood as limiting the invention.

The above embodiments only describe preferred modes of the invention, rather than limit the scope of the invention. Without departing from the design spirit of the application, all kinds of modifications and improvements made by those of ordinary skill in the field to the technical scheme of the invention should fall within the protection scope determined by the appended claims of the invention.

What is claimed is:

1. A comprehensive evaluation method of military training level based on a multi-source data fusion model, wherein the comprehensive evaluation method of military training level includes the following steps:
selecting evaluation indicators of military training level, and establishing an evaluation indicator system of military training level by using a multi-tree structure;
constructing a leaf node evaluation indicator fusion model of military training level based on a multi-source data fusion algorithm, and performing multi-source data fusion processing on leaf node evaluation indicator data through the leaf node evaluation indicator fusion model of military training level, wherein the leaf node evaluation indicator fusion model comprises a time indicator fusion model and a quality indicator fusion model, the time indicator fusion model is constructed based on an improved sigmoid function while the quality indicator fusion model is constructed based on a percentage of completion quality of military training actions;
constructing a leaf node evaluation indicator model of military training level, based on the multi-tree structure of the evaluation indicator system of military training level and the leaf node evaluation indicator data after the multi-source data fusion processing;
constructing a parent node evaluation indicator model of military training level, based on weight information of evaluation indicators of military training level of nodes in the multi-tree structure of the evaluation indicator system of military training level;
constructing a total indicator evaluation model of military training level by using a method of breadth first search of multi-tree, based on the leaf node evaluation indicator model of military training level and the parent node evaluation indicator model of military training level, and thereby completing a comprehensive evaluation of military training level.

2. The comprehensive evaluation method of military training according to claim 1, wherein the time indicator fusion model is shown in Formula 2:
$$v = \frac{1}{1 + {e}^{α t - β}} , v ∈ ( 0 , 1 ) \qquad Formula 2$$
where, an expression of β is shown in Formula 3:
$$β = α {t}_{{stan}^{.}} - ln ( \frac{1}{{v}_{stan}} - 1 ) , β ∈ ( 0 , 1 ) \qquad Formula 3$$
where, t represents an actual time of the military training actions, v represents an actual completion speed of the military training actions, α and β represent a slope factor and a bias factor respectively, tₛₜₐₙ represents a standard time of the military training actions, vₛₜₐₙ represents a standard completion speed of the military training actions corresponding to tₛₜₐₙ, and Vₛₜₐₙ=f(β−atₛₜₐₙ);
wherein the quality indicator fusion model is shown in Formula 4:
$$q = \frac{m}{{m}_{total}} , q ∈ ( 0 , 1 ) \qquad Formula 4$$
where, m represents the number of correct actions in the military training operations, and mₜₒₜₐₗ represents the total number of actions in the military training operations.

3. The comprehensive evaluation method of military training level according to claim 2, wherein the leaf node evaluation indicator model s of military training level is shown in Formula 5:
$$s = \{ \begin{matrix}v \times 100 = \frac{1}{1 + {e}^{α t - β}} \times 100 , & \begin{matrix}when the leaf node is a \\ time indicator\end{matrix} \\ q \times 100 = \frac{m}{{m}_{total}} \times 100 , & \begin{matrix}when the leaf node is a \\ quality indicator\end{matrix}\end{matrix} . \qquad Formula 5$$

4. The comprehensive evaluation method of military training level according to claim 3, wherein the parent node evaluation indicator model S of military training level is shown in Formula 6:
$$S = {\sum }_{i = 1}^{N} \frac{{w}_{i}}{{\sum }_{j = 1}^{N} {w}_{i}} {s}_{i} \qquad Formula 6$$
where, N represents the number of child nodes owned by a parent node, Sᵢ, represents an indicator evaluation result of the i-th child node, and Wᵢ, represents an indicator weight of the i-th child node.

5. The comprehensive evaluation method of military training level according to claim 1, wherein the method of breadth first search of multi-tree is implemented by a queue.

6. The comprehensive evaluation method of military training level according to claim 1, wherein the method breadth first search of multi-tree with bottom-up and hierarchical weighted summation is used to construct the total indicator evaluation model of military training level.
